(19) United States
(12) Patent Application Publication
(10) Pub. No.: US 2021/0046344 A1
(43) Pub. Date: Feb. 18, 2021

(54) Fire Suppression System for Tanks

(71) Applicant: Lightning Master Corporation, Clearwater, FL (US)

(72) Inventor: Bruce Kaiser, Clearwater, FL (US)

(21) Appl. No.: 16/994,853

(22) Filed: Aug. 17, 2020

Related U.S. Application Data
(60) Provisional application No. 62/888,040, filed on Aug. 16, 2019.

(51) Int. Cl. A62C 35/10; A62C 99/00; A62C 35/02

(52) U.S. Cl. CPC A62C 35/10; A62C 35/023; A62C 99/0018

(57) ABSTRACT

Fire suppression system to extinguish fires present within tanks. The system includes a cylindrical suppression unit that contains a cylindrical aerosol generator. The suppression unit prevents the aerosol generator from sliding into the tank and allows a user to removably attach the system to and from the tank. The aerosol generator uses a potassium aerosol to extinguish the fire and may be engaged via a bulb-thermal actuator or heating of the bulk material that composes the aerosol.

### CROSS-REFERENCE TO RELATED APPLICATIONS

This application claims priority to pending provisional application No. 62/888,040, filed Aug. 16, 2019, the disclosure of which is hereby incorporated by reference herein.

### BACKGROUND OF THE INVENTION

### Field of the Invention

The described invention relates to a device that suppresses fires within tanks. Specifically, this invention allows a user to attach the device to a production, disposal, vapor recovery, heater treater, separator or other tanks (“tanks”), whereby once a fire is present within the tank, the device engages and extinguishes the fire by the use of aerosols.

### Description of the Background Art

Typically, crude oil is extracted from the ground and placed into large tanks for further processing and storage. For ease of accessibility, these tanks are often placed in close proximity to one other in a cluster formation which can be problematic as each tank generates a considerable amount of static electricity and is also subjected to lightning storms. Static electricity or lightning strikes can ignite the tank contents. Once ignited, the fire expands within the tank and the tank explodes which can cause a chain reaction with the nearby tanks.

To prevent these fires from destroying the tanks, typical systems use pressurized canisters or systems of flame-retardant chemicals to extinguish any fires. Often, these canisters or systems themselves are housed as central units and are connected to the tanks via a system of pipes or tubes. Thus, the removability and reusability is limited.

Furthermore, once these typical canisters or systems release their chemicals, they mix with the tank contents which then requires further processing to remove the added chemicals. Additionally, the canisters or systems are pressurized themselves and often contribute to the pressurization of the tank.

Therefore, it is an object of this invention to provide an improvement which overcomes the aforementioned inadequacies of the prior art devices and provides an improvement which is a significant contribution to the advancement of the fire suppression systems for tanks.

Another object of the invention is to provide a suppression unit that encases an aerosol generator and are collectively removably attached to a port of a tank.

Another object of the invention is to use an aerosol generator that is composed of a solid bulk compound that does not contribute to the pressurization of a tank and further, only adds salt to the already salty tank contents.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The present invention relates generally to a fire suppression system that extinguishes fires that may start within tanks. The fire suppression system includes two components, a suppression unit and aerosol generator. The aerosol generator is contained within the suppression unit and the suppression unit has a threaded end to connect to the tank. In other words, the aerosol generator does not connect to the tank, but the suppression unit does, while containing the aerosol generator. The aerosol generator uses a potassium aerosol that is effective at interrupting the chemical reaction chain of fire and includes a bulb-thermal actuator that engages the aerosol to release into the tank. Notably, the bulb-thermal actuator need not be present on the aerosol generator because the solid bulk compound ignites when a certain temperature is reached. The solid bulk compound within the aerosol generator is an aerosol and thus, does not contribute to the pressurization of the tank, which typically has relief valves set at 15 ounces. Furthermore, the solid bulk compound comprises potassium nitrate, potassium carbonate, and magnesium collectively bound in a resin polymer. Once released to extinguish a fire, the compound only increases the salinity of the tank contents, which is typically salty itself.

The suppression unit is configured to be removably attached to the tank such that the suppression unit may be transportable, removable, reusable, relocatable, etc. It also includes an inner stopper that prevents the aerosol generator from sliding into the tank and further, it includes an end cap that allows a user to inspect the aerosol generator without removing the suppression unit from the tank.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a front elevational view of a system, which includes a suppression unit and aerosol generator;

FIG. 2 is front elevational view of the suppression unit;

FIG. 3 is a perspective view of the suppression unit;

FIG. 4 is a top perspective view of the suppression unit, specifically showing an inner stopper;

FIG. 5 is a cross sectional view of the system when the aerosol generator is contained within the suppression unit;

FIG. 6 is a front elevational view of a membrane that attaches to a threaded end of a proximal end of the suppression unit;

FIG. 7 is a front elevational view of the aerosol generator;

FIG. 8 is a front elevational view of an optional bulb-thermal actuator removably attached to a upper surface of the aerosol generator;

FIG. 9 is a top perspective view of the optional bulb-thermal actuator removably attached to the upper surface of the aerosol generator;

FIG. 10 is a bottom perspective view of the aerosol generator;

FIG. 11 is a top perspective view of the aerosol generator contained within the suppression unit;

FIG. 12 is a top perspective view of the aerosol generator contained within the suppression unit, including a spring;

FIG. 13 is a top perspective view of the aerosol generator contained within the suppression unit, including an end cap;

FIG. 14 is a front perspective view of the end cap;

FIG. 15 is a front perspective view of the spring;

FIG. 16 is a view of a standard tank;

FIG. 17 is a top perspective view of a second embodiment of the suppression unit, specifically showing heat rails;

FIG. 18 is a top perspective view of the brackets equipped to the aerosol generator;

FIG. 19 is a top perspective view of the aerosol generator having the brackets placed within the second embodiment of the suppression unit;

FIG. 20 is a view of the second embodiment of the suppression unit attached to a tank; and

FIG. 21 is a front elevational view of the stopper.

Similar reference numerals refer to similar parts throughout the several views of the drawings.

### DETAILED DESCRIPTION OF THE DRAWINGS

The following description is of the best mode presently contemplated for carrying out the invention. This description is not to be taken in a limiting sense, but is made merely for the purpose of describing one or more preferred embodiments of the invention.

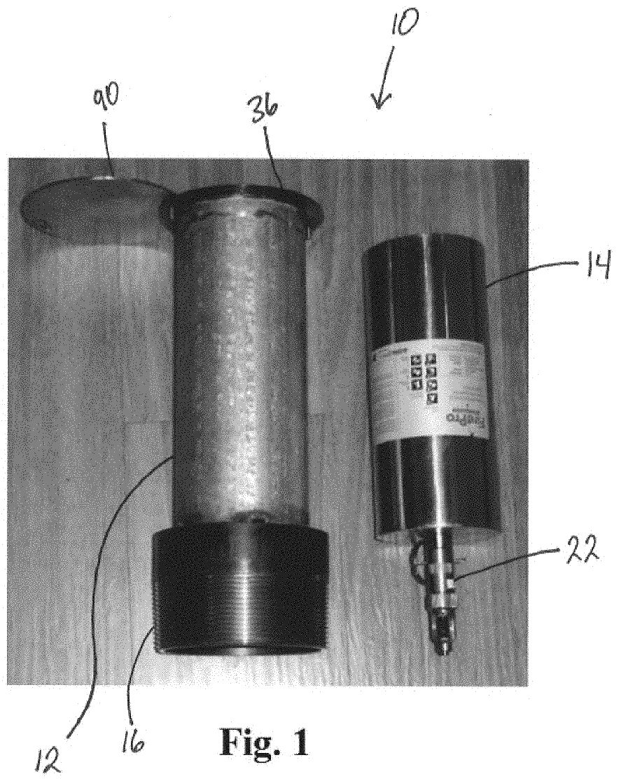

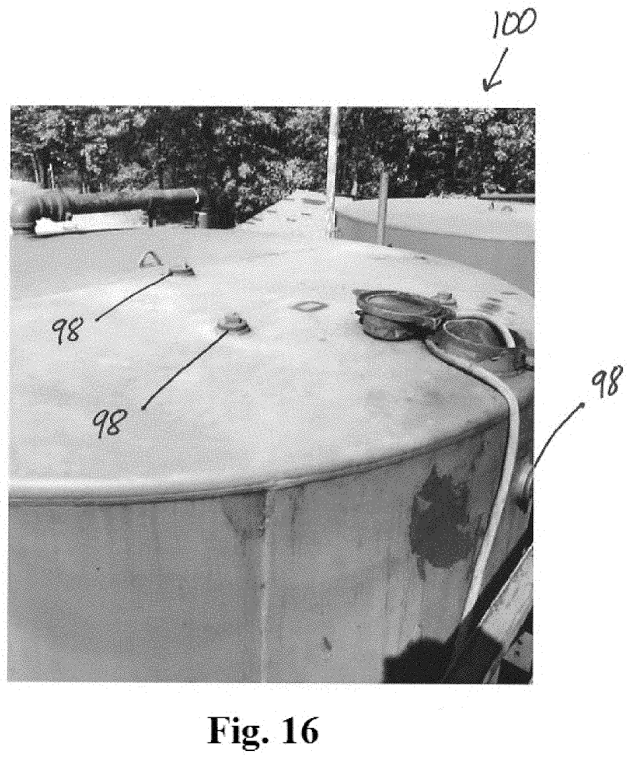

FIG. 1 represents two components of a fire suppression system 10, which includes a suppression unit 12 and aerosol generator 14. The system 10 removably mounts to a port 98 of a tank 100 (shown in FIG. 16). The aerosol generator 14 removably slides into the suppression unit 12, which can collectively be removably connected to the port 98 and remain outside the tank 100.

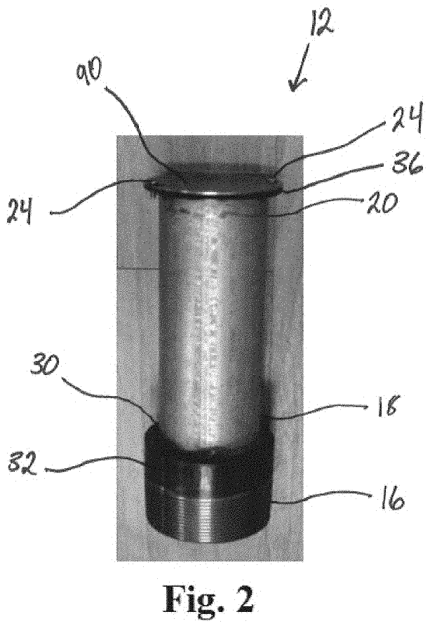

FIG. 2 represents the suppression unit 12, which includes an end cap 90 that connects via screws 24 to a top surface 36 of the suppression unit's 12 distal end 20. Notably and as shown in FIG. 1, the cap 90 may have one of its screws 24 removed such that the other screw 24 is engaged to the top surface 36 to allow the end cap 90 to freely rotate around the distal end 20 while having the engaged screw 24 acting as a pivot point. The suppression unit 20 also includes a proximal end 18 which is connected to a base 32. The base 32 has a threated end 16 that allows the suppression unit 12 to be removably connected to the port 98. The base 32 is connected to the proximal end 18 of the suppression unit 12 via the use of a welding joint 30 which uses any conventional technique of connecting two metals together, such as welding, riveting, brazing, soldering, gluing, or using an epoxy mix, but preferably welding. Further techniques to connect the base 32 to the proximal end 18 that stray away from the aforementioned would generally be considered to perform the same function, way, and result as the claimed invention because the aforementioned techniques are used to create an airtight seal having sufficient strength to mimic the material characteristics of the associated metals.

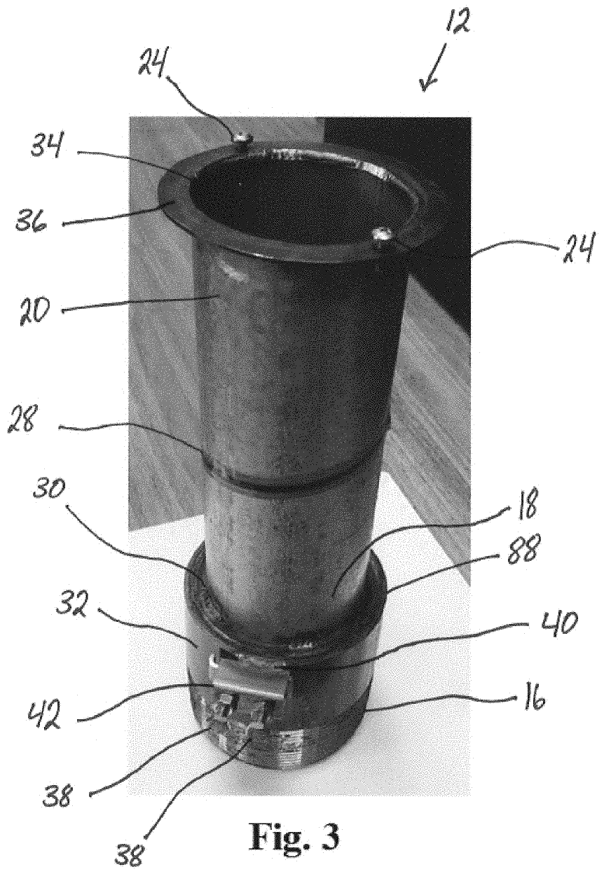

FIG. 3 shows the suppression unit 12 having an exposed inner wall 34 without the cap 90 affixed. The suppression unit 12 also includes a temperature-dependent strip 28 that allows a user to determine when the suppression unit 12 has been fired/engaged. As detailed later, the suppression unit 12 encloses the aerosol generator 14, which fires when it receives a sufficient temperature trigger. Once that happens, the aerosol generator 14 releases its aerosol gas which flows into the tank 100. The strip 28 then changes colors or intensity of its single color, such that the user can view when the system 10 has been fired. Notably, the temperature-dependent strip 28 may be a coating or paint that has temperature dependent properties. Thus, the temperature-dependent strip 28 is not limited to a strip-like geometry.

As can also be seen in FIG. 3 is that the base 32 has an outer circumference 88, which is larger than the circumference of the proximal end 18. One of the primary purposes of this outer circumference 88 is to provide the suppression unit 12 with the base 32 that has more strength than simply incorporating the threaded end 16 with a circumference of the proximal end 18. As such, a similar system may be produced that includes a base that has the same circumference as the proximal end 18, but it would ultimately perform the same function, way, and result as the aforementioned because the strength of said chosen base may have similar strength characteristics as the suppression unit 12 disclosed herein, such that a larger circumference may not be needed. Furthermore, the top surface 36 has a larger circumference than the distal end 20 of the suppression unit 12 such that the screws 24 have a horizontal surface to securely connect to the cap 90 to the top surface 36. The top surface 36 extends around the circumference of the distal end 20, similar to a ring-like protrusion.

FIG. 3 also includes an integral electrical bonding lug 42 that acts as a bracket to allow a conductive wire to be attached to the suppression unit 12, to dissipate any accumulated static electricity from the system 10 thereby preventing unwanted fires. The bonding lug 42 allows the conductive wire to be inserted inside itself and which then securely clamps to the bonding lug 42 via bonding lug screws 38.

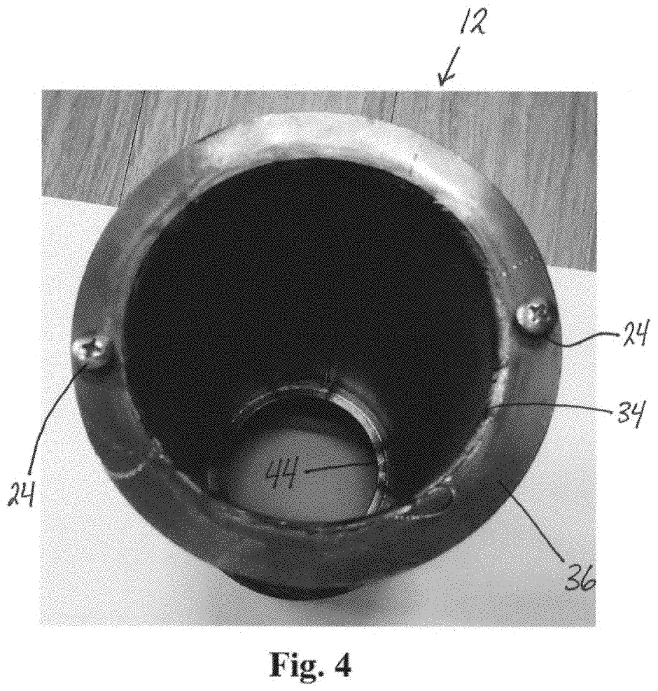

FIG. 4 shows the suppression unit 12 having an inner stopper 44 that prevents the aerosol generator 14 from sliding entirely past the base 32 of the suppression unit 12. The inner stopper 44 is located within the inner wall 34 and located near the proximal end 18, but will perform the same function if placed closer towards the distal end 20, depending on the length of a chosen aerosol generator. The inner stopper 44 may also be connected to the inner wall 34 by any conventional technique of connecting two metals together, such as welding, riveting, brazing, soldering, gluing, or using an epoxy mix, but preferably welding.

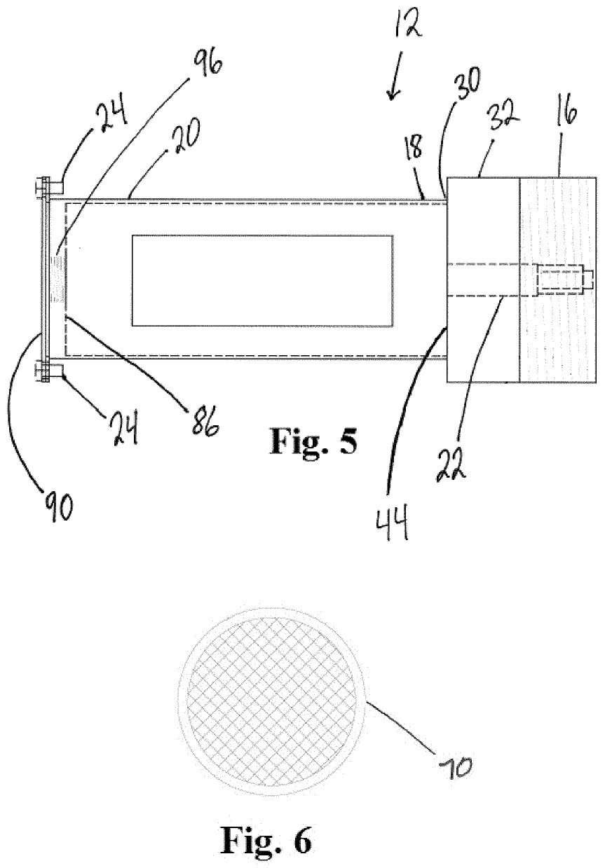

FIG. 5 shows the aerosol generator 14 contained within the suppression unit 12. Notably, the aerosol generator 14 has a length similar to the suppression unit 12; however, the length of the aerosol generator 14 may vary and thus, the two lengths do not need to be similar. More detailed below is a bulb-thermal actuator 22 that engages the aerosol generator 14, once a fire begins.

FIG. 6 represents a membrane 70 that is attached within the threaded base 16 of the suppression unit 12 to prevent any hydrocarbon gases from entering the interior of the suppression unit 12. Once a fire is detected within the tank 100, the membrane 70 will melt, allowing the aerosol to be released from the system 10 into the tank 100.

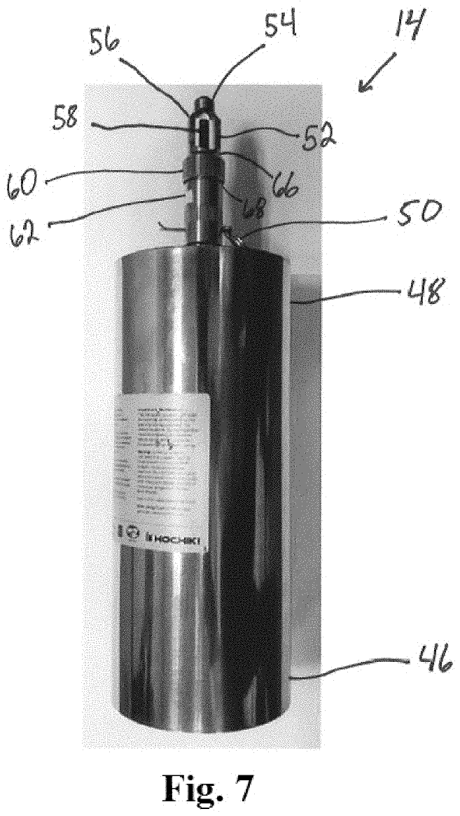

FIG. 7 represents a front elevational view of the aerosol generator 14, which includes an upper end 48 and lower end 46. The upper end 48 contacts the inner stopper 44 (shown in FIG. 4) of the suppression unit 12 to prevent the aerosol generator 14 from sliding past the base 32 of the suppression unit 12.

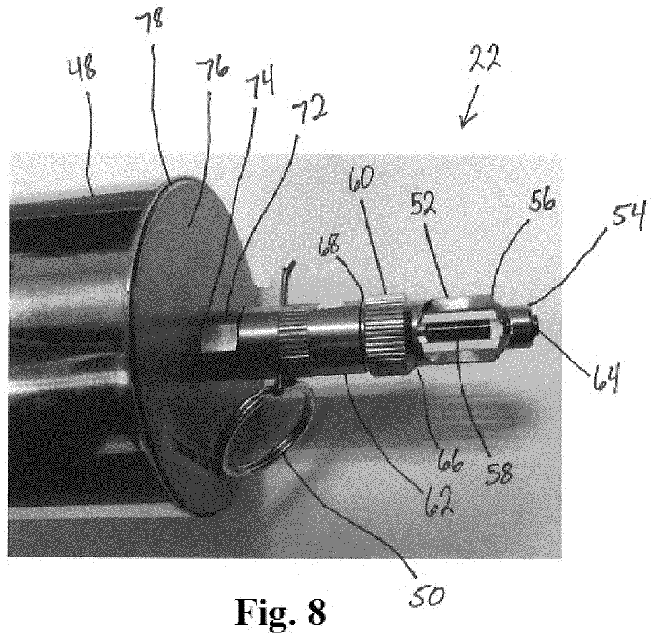

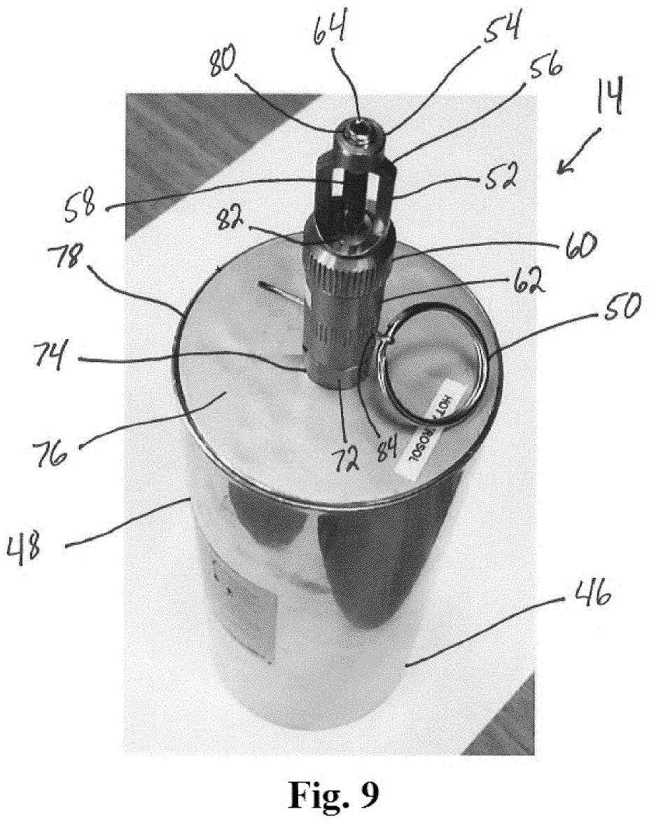

FIGS. 8 and 9 show the upper end 48 of the aerosol generator 14 that includes the bulb-thermal actuator 22, which engages the aerosol generator 14 to fire. This bulb-thermal actuator 22 and aerosol generator 14 may be any temperature-dependent bulb actuator and aerosol generator used in the industry, preferably the FirePro Xtinguish™ by Hochiki America Corporation, modified to have the aerosol exit the upper surface 76 of the aerosol generator 14, as opposed to exiting the lower surface 86 of the aerosol generator 14. Further, the dimensions of the suppression unit 12 are entirely dependent on the actuator and aerosol generator used.

The bulb-thermal actuator 22 includes a sensing bulb 58 enclosed within two supporting arms 52 that prevent the sensing bulb 58 from receiving external forces that may disrupt or engage the bulb-thermal actuator 22 from prematurely firing. The bulb-thermal actuator 22 includes several components typical of a standard bulb-thermal actuator, such as an upper actuator segment 60 that removably connects to the lower actuator segment 62 at connection surface 68. As shown, the upper actuator segment 60 has a larger circumference than that of the supporting arms 52 beginning at point 66. The bulb-thermal actuator 22 fires when the sensing bulb 58 reaches an activation temperature of 182° C. (359° F.) at which point the sensing bulb 58 will burst, allowing the bulb-thermal actuator 22 to actuate its internal firing pin, which pierces the aerosol generator 14.

Notably, the aerosol within the aerosol generator 14 is a solid bulk compound (known as “SBC” or “SBK”) that will self-activate at 300° C. (572° F.). Thus, if the sensing bulb 58 malfunctions or is not installed, the system 10 will continue to operate. The SBC includes potassium salts, K₂CO₃, and is a compact, strong solid that is non-toxic and transforms from a stable solid phase to a gaseous aerosol phase upon activation. The SBC is housed within the aerosol generator 14 at a location closest to the upper surface 76. The SBC is particularly useful in extinguishing fires because it is composed of certain salts that interrupt the chemical chain reaction of fire, typically being four times more effective as Halon, by weight. Furthermore, using salts as the extinguishing medium only increases the salinity of the crude oil, which already has large amounts of salts when extracted from the earth.

Notably, the bulb-thermal actuator 22 is optional. The system 10 can work in a similar fashion without the bulb-thermal actuator 22 since the solid bulk compound within the aerosol generator 14 can self-ignite without the aid of the bulb-thermal actuator 22. Thus, including the bulb-thermal actuator 22 is optional, and need not be included for the purpose of this invention.

The lower actuator segment 62 connects to the aerosol generator's 14 upper surface 76 via a bolt 72 located at connection location 74. The connection location 74 may be in the center of the upper surface 76 or it may be located at any location of the upper surface 76. The lower actuator segment also includes a pin 50 that prevents the firing of the bulb-thermal actuator 22.

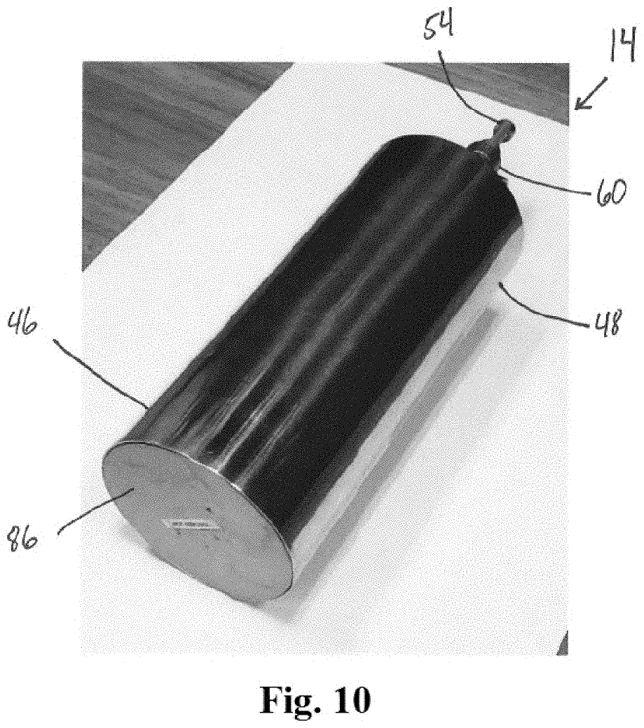

FIG. 10 shows the aerosol generator's 14 lower surface 86 which is located near and perpendicular to the lower end 46.

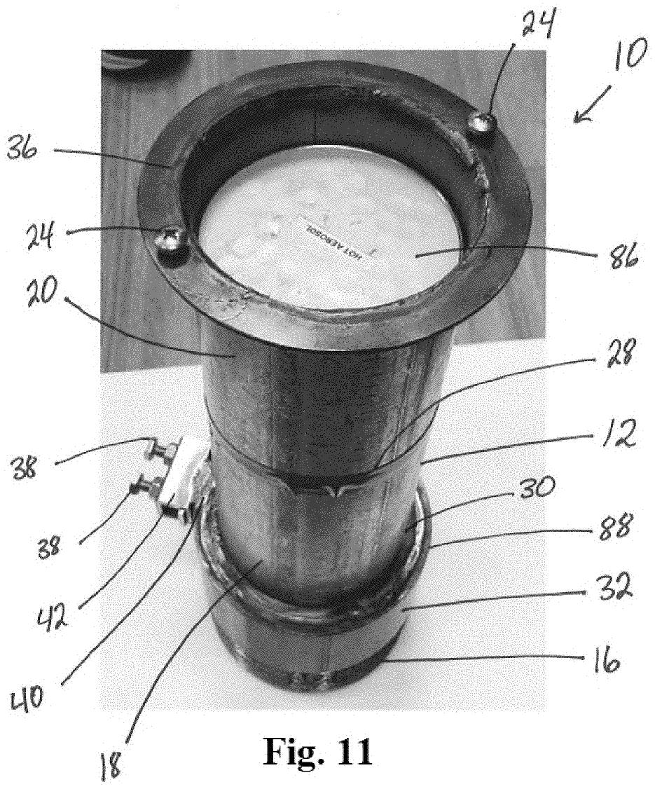

FIG. 11 shows the aerosol generator 14 fitted within the suppression unit 12. The upper end 48 of the aerosol generator 14 first slides into the distal end 20 of the suppression unit 12 and once fully inserted, the lower end 46 of the aerosol generator 14 is located near the distal end 20 of the suppression unit 12, whereas the upper end 48 of the aerosol generator 14 is located near the proximal end 18 of the suppression unit 12. Notably, the lower surface 86 is exposed and a gap exists between the lower surface 86 of the aerosol generator 14 and the top surface 36 of the suppression unit 12.

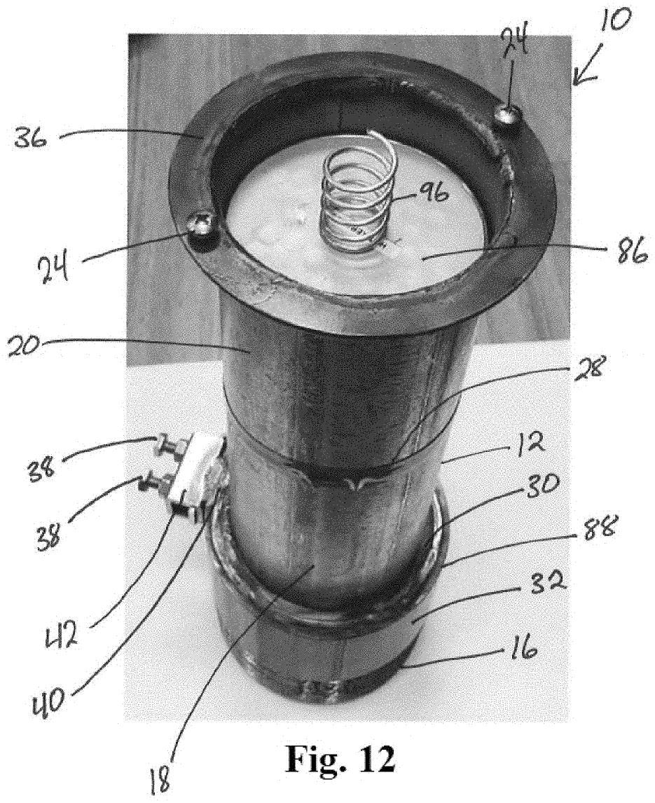

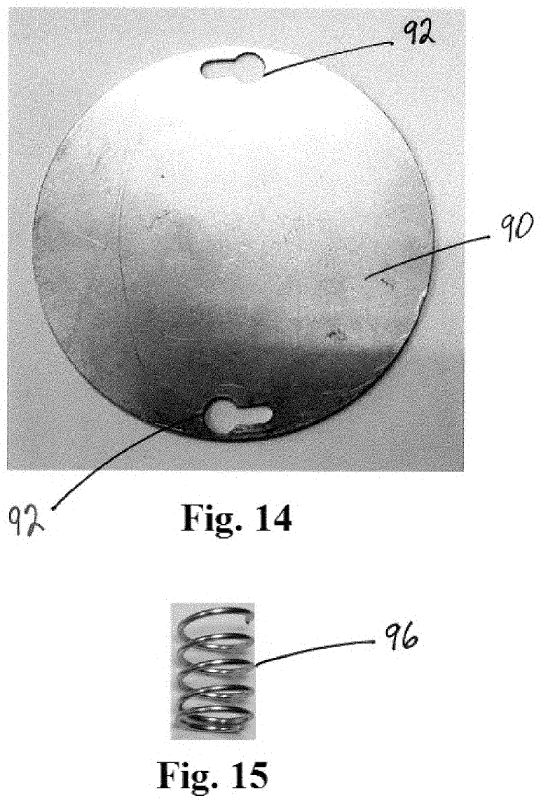

FIG. 12 shows the aerosol generator 14 fitted within the suppression unit 12, including a spring 96 (FIG. 14) that is placed within the gap between the lower surface 86 of the aerosol generator 14 and the top surface 36 of the suppression unit 12 to prevent the aerosol generator 14 from appreciably moving within the suppression unit 12. While the system 10 is installed to the tank 100, the spring 96 allows the aerosol generator 14 to move within the suppression unit 12 in response to an applied force such that the aerosol generator 14 may move towards the top surface 36 of the suppression unit 12, without damaging the end cap 90. The spring 96 also prevents a vibration or rattling effect from occurring within the system 10.

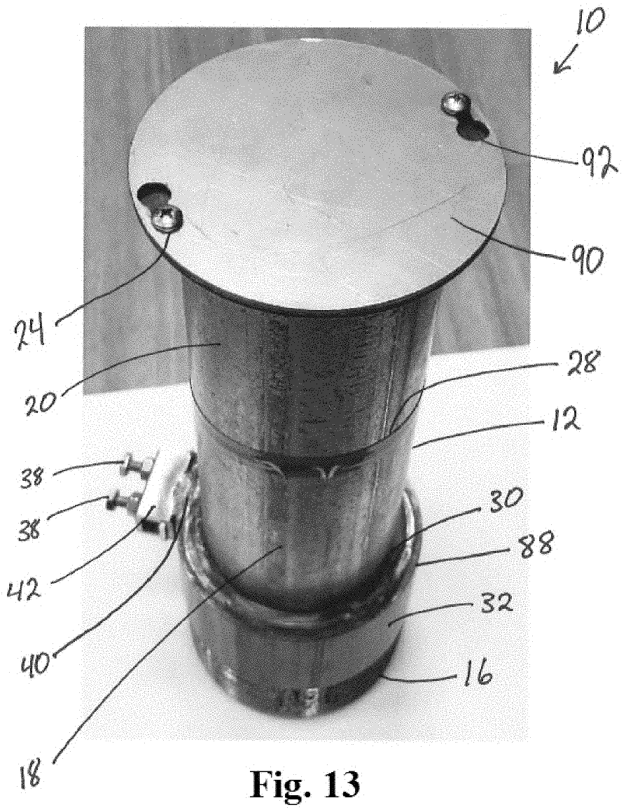

FIGS. 13 and 5 show the fully assembled system 10 with the end cap 90 (FIG. 14) installed onto the top surface 36 of the suppression unit 12 via the screws 24 inserted into screw holes 92 (FIG. 14).

FIG. 16 shows a standard tank 100 that typically includes multiple ports 98 that allow the threaded end 16 of the suppression unit 12 to install into. Thus, the fire suppression system 10 installs onto the port 98.

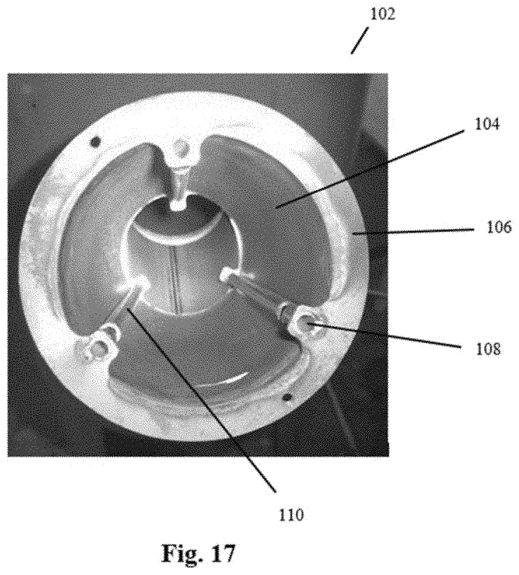

FIG. 17 shows a second embodiment of the suppression unit 12 which includes heat rails 110 composed of a heat-conductive material such as copper that allow transfer of heat generated from within a tank 120 during a fire in the tank 120 to the aerosol generator 14. The heat rails 110 extend along the length of the interior wall 104 of the suppression unit 102. Heat rails 110 (e.g., 3 equally-spaced) may also serve to center the aerosol generator 14 and to provide a space for better heat transfer to the stopper 112 (see below).

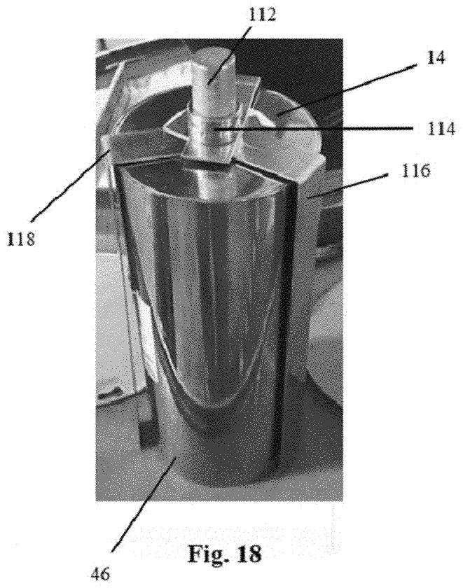

FIG. 18 shows the aerosol generator 14 without the bulb-thermal actuator 22 attached. Conversely, this embodiment shows a stopper 112 as a placeholder for the bulb-thermal actuator 22 which removes the need of the actuator 22 because the SBC within the aerosol generator 14 can itself ignite when a fire is present, without having the actuator 22 prematurely firing the aerosol generator. This embodiment also includes a bracket 118 which is typically made of copper to act as a heat transfer mechanism, but it also allows the aerosol generator 14 to have a larger circumference to prevent any movement while contained within either embodiment of the suppression units. The heat exchanging process of the bracket 118 is accomplished primarily from the large surface area provided by its legs 116. The bracket 118 is attached to the connection location 74 of the generator 14.

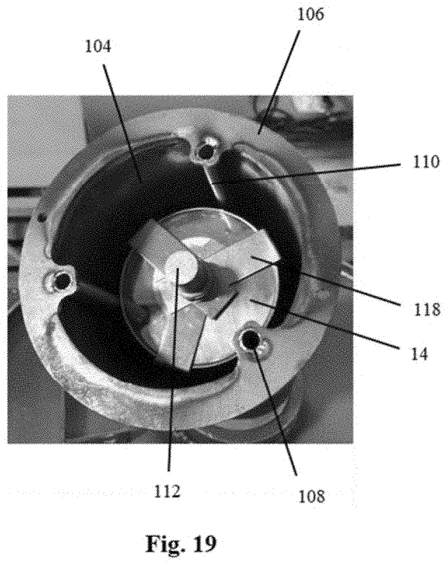

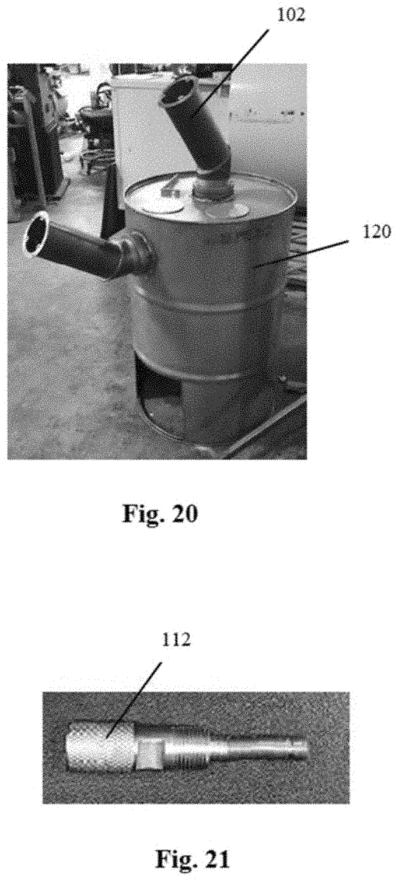

FIG. 19 shows the aerosol generator 14 contained within the second embodiment of the suppression unit 102. FIG. 20 shows the second embodiment of the suppression unit 102 attached to an exemplary tank 120 at approximately a 40 degree angle to prevent the generator 14 from inadvertently falling into the tank 120 during installation or maintenance. FIG. 21 shows the stopper 112 which is inserted into the aerosol generator 14. This stopper 112 typically melt at around temperatures of 572° F., which would ignite the SBC within the generator 14 to extinguish any fires present within the tank 120. If the stopper 112 is used as opposed to the bulb-thermal actuator 22 then the stopper 112 would connect to the generator 14 at connection location 74.

Now that the invention has been described,

What is claimed is:

1. A fire suppression generator for a suppression unit, comprising:
an aerosol generator to be inserted within the suppression unit, said aerosol generator comprising a stopper and a bracket operatively connected to said stopper.

2. The generator of claim 1 wherein the bracket is composed of copper.

3. The generator of claim 1 wherein the bracket includes legs that extend the length of the aerosol generator.

4. A fire suppression unit, comprising:
an aerosol generator to be inserted within a suppression unit, said aerosol generator comprising a connection location; and
said suppression unit comprising distal and proximal ends, said distal end connected to a cap and said proximal end connected to a base.

5. The unit of claim 4 wherein the connection location attaches a stopper.

6. The unit of claim 4 wherein the connection location attaches to a bulb-thermal actuator.

7. The unit of claim 4 wherein the generator includes a bracket operatively connected to the connection location.

8. The unit of claim 4 wherein the base includes a threaded end.

9. The unit of claim 4 wherein the base is cylindrical.

10. The unit of claim 4 wherein the suppression unit includes heating rails.

11. A fire suppression system for a tank, comprising in combination:
an aerosol generator to be inserted within a suppression unit, said aerosol generator comprising a connection location;
said suppression unit comprising distal and proximal ends, said distal end connected to a cap and said proximal end connected to one end of a base; and
said base further connected to a tank.

12. The system of claim 5 wherein the connection location attaches a stopper.

13. The system of claim 5 wherein the connection location attaches to a bulb-thermal actuator.

14. The system of claim 5 wherein the generator includes a bracket operatively connected to the connection location.

15. The system of claim 5 wherein the base includes a threaded end.

16. The system of claim 5 wherein the base is cylindrical.

17. The system of claim 11 wherein the suppression unit includes heating rails.

18. The system of claim 11 wherein the suppression unit is mounted to the tank at an angle to prevent inadvertent falling of the generator into the tank.
